(19) United States
(12) Patent Application Publication
(10) Pub. No.: US 2026/0343446 A1
(43) Pub. Date: Oct. 29, 2026

(54) GRAND MASTER SWITCHING FOR FRONTHAUL SYNCHRONIZATION

(71) Applicant: QUALCOMM Incorporated, San Diego, CA (US)

(72) Inventors: Aman Kumar SINGH, Hyderabad (IN); Loksiva PARUCHURI, Hyderabad (IN)

(21) Appl. No.: 19/189,585

(22) Filed: Apr. 25, 2025

(51) Int. Cl. H04W 56/00; H04L 5/00

(52) U.S. Cl. CPC H04W 56/0015; H04L 5/0055

(57) ABSTRACT

Aspects relate to enablement of Grand Master switching for fronthaul synchronization. An Open-Radio Access Network (O-RAN) Distributed Unit (O-DU) transmits an indication to an O-RAN Radio Unit (O-RU) to operate as a synchronization source for the O-DU. The indication is associated with a synchronization drift in the O-DU. The O-DU receives synchronization data from the O-RU and restores synchronization in the O-DU based on the synchronization data.

### BACKGROUND

### Field of the Disclosure

The present disclosure relates generally to wireless communication systems, and, more particularly, to synchronization in wireless communication systems.

### Description of Related Art

Wireless communication systems are widely deployed to provide a range of communication services such as telephony, data transmission, messaging, multimedia streaming, broadcasting, or the like. The wireless communication systems may enable communication between multiple users by employing various multiple-access technologies, For example, Code Division Multiple Access (CDMA), Time Division Multiple Access (TDMA), Frequency Division Multiple Access (FDMA), Orthogonal Frequency Division Multiple Access (OFDMA), or the like. Examples of wireless multiple-access communication systems may include fourth-generation (4G) systems such as Long-Term Evolution (LTE) systems, LTE-Advanced (LTE-A) systems, or LTE-A Pro systems, and fifth-generation (5G) systems which may be referred to as New Radio (NR) systems. A wireless multiple-access communication system may include one or more base stations that enable wireless communication for communication devices such as User Equipment (UE).

In the context of an Open Radio Access Network (O-RAN) architecture, functions of a base station or a network node may be disaggregated across multiple network entities. For example, an O-RAN network node may include an O-RAN Radio Unit (O-RU) and an O-RAN Distributed Unit (O-DU). The O-RU may handle wireless communications with devices, such as UEs, whereas the O-DU may support the wireless communications performed by the O-RU. The disaggregation of O-RAN network node functionality may enable flexibility and scalability.

### SUMMARY

The systems, methods, and devices of this disclosure each have several innovative aspects, no single one of which is solely responsible for the desirable attributes disclosed herein. In Open Radio Access Network (O-RAN) architecture, functions of a base station or a network node may be disaggregated across multiple network entities such as an O-RAN Radio Unit (O-RU) and an O-RAN Distributed Unit (O-DU). Disaggregation of O-RAN network node functionality may involve synchronization between the O-DU and the O-RU to enable seamless operation. Proper communication in the O-RAN architecture may depend on the precise coordination between the O-DU and O-RU. However, challenges arise when there is any misalignment or delay between the O-DU and O-RU, leading to reduced network performance, service interruptions, or degraded quality of experience for users.

To maintain the synchronization of the O-DU, the O-DU may indicate the O-RU to act as a synchronization source in case of synchronization drift in the O-DU. In response, the O-DU may receive synchronization data from the O-RU. Further, the O-DU may restore synchronization in the O-DU based on the received synchronization data.

The following is a summary of some non-limiting aspects of the disclosure:

A synchronization method in an O-DU is described. The synchronization method may include transmitting, an indication to an ORAN Radio Unit (O-RU) to operate as a synchronization source for the O-DU. The indication may be associated with a synchronization drift in the O-DU. The synchronization method may include receiving, from the O-RU, synchronization data and restoring synchronization in the O-DU based on the synchronization data.

An O-DU to enable Grand Master switching for fronthaul synchronization is described. The O-DU may include one or more memories and one or more processors coupled to the one or more memories. The one or more processors may be configured to cause the O-DU to transmit an indication to an O-RAN Radio Unit (O-RU) to operate as a synchronization source for the O-DU. The indication may be associated with a synchronization drift in the O-DU. The one or more processors may be configured to cause the O-DU to receive synchronization data from the O-RU, and restore synchronization in the O-DU based on the synchronization data.

Another O-DU to enable Grand Master switching for fronthaul synchronization is described. The O-DU may include means for transmitting, an indication to an ORAN Radio Unit (O-RU) to operate as a synchronization source for the O-DU. The indication may be associated with a synchronization drift in the O-DU. The O-DU may include means for receiving, from the O-RU, synchronization data and means for restoring synchronization in the O-DU based on the synchronization data.

A non-transitory computer-readable medium storing code for synchronization is described. The code may include instructions executable by one or more processors to transmit an indication to an O-RAN Radio Unit (O-RU) to operate as a synchronization source for the O-DU. The indication is associated with a synchronization drift in the O-DU. The code may include instructions executable by the one or more processors to receive synchronization data from the O-RU, and restore synchronization in the O-DU based on the synchronization data.

A synchronization method in an O-RU is described. The synchronization method may include receiving, from an O-DU, an indication to operate as a synchronization source for the O-DU, and transmitting synchronization data to the O-DU in response to the indication.

An O-RU to enable Grand Master switching for fronthaul synchronization is described. The O-RU may include one or more memories and one or more processors coupled to the one or more memories. The one or more processors may be configured to cause the O-RU to receive, from an O-DU, an indication to operate as a synchronization source for the O-DU. The one or more processors may be configured to cause the O-RU to transmit synchronization data to the O-DU in response to the indication.

Another O-RU to enable Grand Master switching for fronthaul synchronization is described. The O-RU may include a means for receiving, from an O-DU, an indication to operate as a synchronization source for the O-DU, and a means for transmitting synchronization data to the O-DU in response to the indication.

A non-transitory computer-readable medium storing code for synchronization is described. The code may include instructions executable by one or more processors to receive, from an O-DU, an indication to operate as a synchronization source for the O-DU, and transmit synchronization data to the O-DU in response to the indication.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates an example of a wireless communication system, in accordance with certain aspects of the present disclosure;

FIG. 2 is a diagram that illustrates an example of an Open Radio Access Network (O-RAN) architecture, in accordance with certain aspects of the present disclosure;

FIG. 3 is a diagram that illustrates an example of a message flow between an O-RAN Distributed Unit (O-DU) and an O-RAN Radio Unit (O-RU), in accordance with certain aspects of the present disclosure;

FIG. 4 is a diagram that illustrates a high-level flowchart for a synchronization process (e.g., a method), in accordance with certain aspects of the present disclosure;

FIG. 5 is a diagram that illustrates a flowchart for a synchronization process (e.g., a method), in accordance with certain aspects of the present disclosure;

FIG. 6 is a diagram that illustrates a high-level flowchart for a process (e.g., a method) for executing Grand Master switching for fronthaul synchronization, in accordance with certain aspects of the present disclosure;

FIG. 7 is a diagram that illustrates a flowchart for a process (e.g., a method) for executing Grand Master switching for fronthaul synchronization, in accordance with certain aspects of the present disclosure;

FIG. 8 is a diagram that illustrates an example of an O-DU, in accordance with certain aspects of the present disclosure; and

FIG. 9 is a diagram that illustrates an example of an O-RU, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

An Open Radio Access Network (O-RAN) architecture may enable the functions of a base station to be disaggregated across multiple devices or components. For example, a Radio Access Network (RAN) node within the O-RAN architecture may include one or more of O-RAN Distributed Units (O-DUs) or O-RAN Radio Units (O-RUs). An O-RU may handle wireless communications with communication devices, such as User Equipment (UE), while an O-DU may support the wireless communications performed by the O-RU. While the disaggregation of base station functionalities allows for flexibility and scalability, the disaggregation of base station functionalities also involves synchronization of the O-DU and the O-RU to ensure seamless operation.

The O-DU may synchronize with a clock source to maintain integrity and reliability of data transmission in the O-RAN environment. The clock source can be remote or local. However, in various scenarios, factors such as network congestion, jitter, hardware imperfections, or environmental conditions can cause synchronization drift in the O-DU. If left unchecked or uncorrected, over time, the synchronization drift accumulates, which can lead to a loss of synchronization between the O-DU and the clock source. Additionally, in such scenarios, radio frequency (RF) transmission on various O-RUs that are connected to the O-DU may be disabled until the O-DU restores synchronization. Hence, control plane/user plane traffic from the O-DU to the various O-RUs may be stopped in the O-RAN architecture. In further examples, transmission array carriers and reception array carriers of the connected O-RUs are disabled when the synchronization in the O-DU is lost. The transmission array carriers and reception array carriers may remain disabled until the synchronization is reacquired by the O-DU. As a result, outage may be caused in the wireless network, which can result in degradation of network performance, increased latency, inaccurate resource scheduling, disruption in the handover process, or the like. Additionally, there is no provision for the O-RU to act as a Telecom Grand Master (T-GM) Clock in the O-RAN architecture despite having a valid clock source.

Certain aspects disclosed herein provide systems and methods for Grand Master switching (also referred to as Grand Master Clock switching) for fronthaul synchronization. Fronthaul may correspond to a communication interface between the O-DU and the O-RU. In an example, the O-DU may transmit an indication to the O-RU to operate as a synchronization source for the O-DU in a case the O-DU is experiencing synchronization drift. The transmitted indication may be associated with the synchronization drift in the O-DU. Thus, by transmitting the indication, the O-DU may request the O-RU to operate as the synchronization source for the O-DU. The O-DU may receive synchronization data from the O-RU. Based on the received synchronization data, the O-DU may restore synchronization. Thus, the O-DU corrects the synchronization drift before synchronization loss.

Since the O-DU synchronizes with the O-RU before synchronization loss, disabling RF transmission on O-RUs that are connected to the O-DU can be prevented. Additionally, disabling the transmission array carriers and the reception array carriers of the connected O-RUs may be avoided. As a result, the degradation of network performance, increased latency, inaccurate resource scheduling, and disruption in the handover process in the wireless network due to synchronization failure in the O-DU can be prevented. Thus, the disclosed aspects may improve network reliability in the O-RAN architecture.

In some aspects, the O-DU may restore synchronization within a switch time-period after the detection of the synchronization drift. In an example, the switch time-period may be less than a holdover expiration time-period associated with the O-DU. The holdover expiration time-period may correspond to a time duration taken by the O-DU to transition from the synchronization drift to loss of synchronization. In an example, the holdover expiration time-period may refer to the time duration for which the O-DU can maintain acceptable synchronization after losing connection to the clock source. The holdover expiration time-period may represent the time taken for synchronization drift to accumulate to a value at which the O-DU can no longer function within a configured timing accuracy, ultimately leading to the loss of synchronization. The switch time-period may correspond to a synchronization window usable for synchronization restoration by the O-DU. As the switch time-period is less than the holdover expiration time-period, the O-DU can be synchronized with the O-RU before losing the synchronization with the clock source.

In some more aspects, the O-RU may receive, from the O-DU, the indication to operate as the synchronization source for the O-DU and transmit synchronization data to the O-DU in response to the indication. Thus, O-RU enables synchronization of the O-DU before the O-DU is out of synchronization with the clock source of the O-DU. For example, the O-RU may enable Grand Master switching (e.g., Grand Master Clock switching) for fronthaul synchronization to prevent the O-DU from being out of synchronization.

In various aspects, the O-RU may transmit the synchronization data to various connected O-RUs, thereby preventing the disabling of the RF transmission on the O-RUs that are connected to the O-DU.

The terms "O-RAN Radio Unit" (O-RU) and "O-RAN Distributed Unit" (O-DU) are used herein for illustrative and descriptive purposes to reference functional components within a wireless communication network. These terms are not intended to limit the scope of the disclosure to any specific terminology or technology. It will be apparent to a person skilled in the art that as technology evolves, these network nodes may be referred to by different names or have different functional groupings. Therefore, the terms O-RU and O-DU can encompass equivalent structures, devices, or functional units regardless of the terminology used in future technologies or implementations.

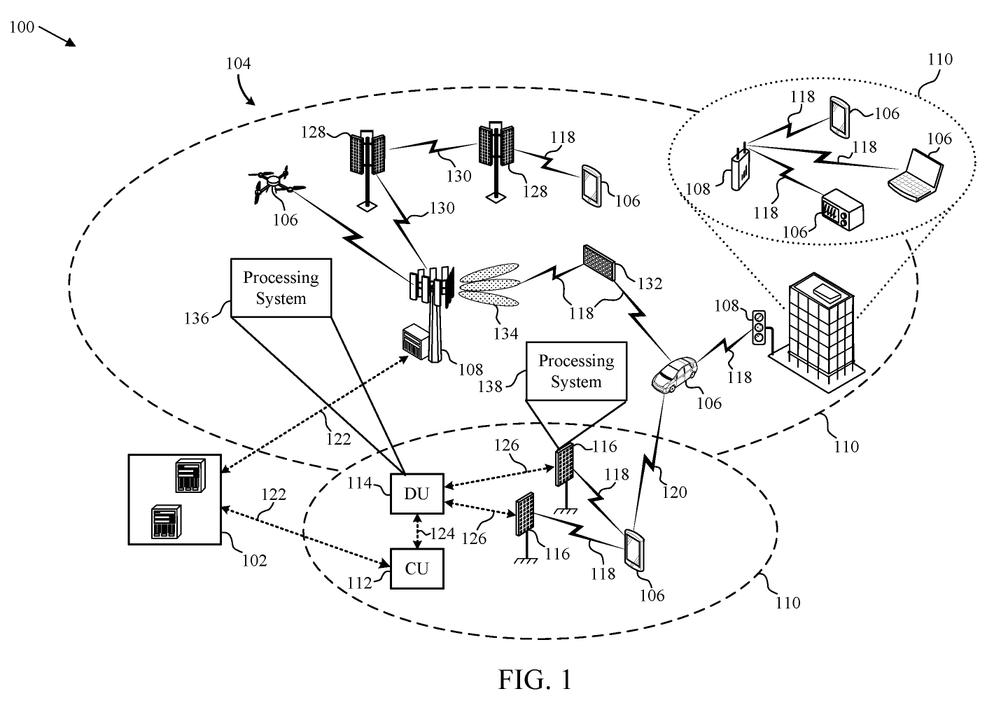

FIG. 1 is a diagram that illustrates an example of a wireless communication system 100, in accordance with certain aspects of the present disclosure. The wireless communication system 100 includes a core network 102 and a RAN 104 that support communication with one or more devices, such as UEs 106. A RAN 104 may include one or more network entities 108 configured to support wireless communication with the UEs 106.

The wireless communication system 100 may support communication among network entities 108 and UEs 106 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A MAC layer may perform priority handling and multiplexing of logical channels into transport channels. A MAC layer may also implement error detection techniques, error correction techniques, or retransmissions. In a control plane, an RRC layer may provide establishment, configuration, and maintenance of an RRC connection between UEs 106 and a network entity 108 or a core network 102, supporting radio bearers for user plane data. A Physical (PHY) layer may map transport channels to physical channels.

A core network 102 may support user authentication, access authorization, tracking, IP connectivity, and other access, routing, or mobility functions (such as via network entities 108). A core network 102 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 108 may support wireless communication in accordance with one or more coverage areas 110, and may be referred to as a network element, a network node, a RAN node, or network equipment, among other nomenclature. One or more of the network entities 108 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 108 support communication for one or more coverage areas 110 using the same or different RATs.

In some examples, a network entity 108 may be implemented in an aggregated (such as monolithic, standalone) architecture, which may utilize a protocol stack that is physically or logically integrated within one network entity 108 (such as a single physical RAN node). In some other examples, a network entity 108 may be implemented in a disaggregated architecture, which may utilize a protocol stack that is physically or logically disaggregated among multiple network entities 108, including in an integrated access and backhaul (IAB) network, an open RAN (O-RAN), or a virtualized RAN (vRAN). In a disaggregated architecture, a network entity 108 may include or be referred to as one or more of a central unit (CU) (such as CU 112), a distributed unit (DU) (such as DU 114), a radio unit (RU) (such as RU 116), or a combination thereof. The wireless communication system 100 may also implement a service-based architecture that provides a modular framework in which control plane functionality and common data repositories may be delivered through a set of interconnected network functions (NFs) that may access services of other NFs.

UEs 106 may be located in a coverage area 110 of one or more network entities 108, and may include or be referred to as an access terminal, a mobile station, a client device, or a subscriber unit. A UE 106 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 108 and a UE 106 may be supported using one or more of a communication link 118 (such as a Uu interface), which may include downlink communication from a network entity 108 to a UE 106, uplink communication from a UE 106 to a network entity 108, or both. Direct wireless communication between UEs 106 may be supported using a communication link 120 (such as a device-to-device (D2D) communication link, a sidelink, a PC5 interface).

Communication between a network entity 108 and a core network 102 may be supported using a backhaul link 122 (such as an S1, N2, N3, NG, or other interface). In some implementations, communication between network entities 108 may be supported using a backhaul link 122 (such as an X2, Xn, or other interface) either directly (such as directly between network entities 108) or indirectly (such as via a core network 102). In some implementations (such as in a disaggregated architecture), communication between a CU 112 and a DU 114 may be supported using a midhaul link 124, and communication between a DU 114 and an RU 116 may be supported using a fronthaul link 126. A backhaul link 122, a midhaul link 124, a fronthaul link 126, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 128, which may act as a relay using resources of an IAB donor network entity 108 (such as via a wireless link 130).

The wireless communication system 100 may include one or more of a relay 132 that may steer or reflect signals transmitted by other entities, which may support any of the described communication links. A relay 132 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 108 and UEs 106 each may include one or multiple antennas. Multiple antennas of such devices may be used to employ techniques such as transmit diversity, receive diversity, Multiple Input Multiple Output (MIMO) communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 108 or a UE 106.

Beamforming, such as directional transmission or directional reception, is a signal processing technique that may be used at a transmitting device or a receiving device (such as at a network entity 108, at a UE 106) to shape or steer a beam 134 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 104) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 118, for a communication link 120, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 108), including in response to network conditions (such as to allocate uplink and downlink BWPs in response to traffic conditions), device capability (such as allocating BWPs with a greater quantity of RBs to UEs 106 with relatively higher capabilities), or both. A UE 106 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 106 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 108, a UE 106) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 104) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 108 may indicate (such as schedule, allocate) communication resources for a UE 106 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs 106. A UE 106 may monitor control regions for control information according to one or more search space sets, which may include a common search space set (such as for sending control information to one or more UEs 106), UE-specific search space sets (such as for sending control information to a UE 106), or a combination thereof. A physical broadcast channel (PBCH) may be used to broadcast parameters to UEs 106 to synchronize with a network entity 108 and establish communications (such as to establish a communication link 118).

Reference signals may be communicated to establish reference characteristics (such as a frequency reference, a temporal reference, a spatial reference, a signal quality reference) between devices of a RAN 104, which may support communication using physical channels. Reference signals communicated between network entities 108 and UEs 106 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 108 and UEs 106 may receive and measure transmitted reference signals to support one or more of these and other functions.

Devices of the wireless communication system 100 may be configured to support one or more aspects of the described techniques for Grandmaster Switching for fronthaul synchronization. For example, a DU 114 may include a processing system 136, and an RU 116 may include a processing system 138, each of which may be configured to cause the respective device to perform (such as being configured as means for performing) one or more of the described operations. By configuring a processing system 136, a processing system 138, or a combination thereof in accordance with the described techniques, the wireless communication system 100 (such as the RAN 104) may support techniques for a Grandmaster Switching for fronthaul synchronization as described herein. For example, the wireless communication system 100 may support an RU 116 to act as Grandmaster to synchronize a DU 114 in case of synchronization drift in the DU 114.

In some implementations, the DU 114 may transmit an indication to the RU 116 to operate as a synchronization source for the DU 114 in a case the DU 114 is experiencing synchronization drift. The transmitted indication may be associated with the synchronization drift in the DU 114. Thus, by transmitting the indication, the DU 114 may request the RU 116 to operate as the synchronization source for the DU 114. The DU 114 may receive synchronization data from the RU 116. Based on the received synchronization data, the DU 114 may restore synchronization. Thus, the DU 114 corrects the synchronization drift before synchronization loss.

Since the DU 114 synchronizes with the RU 116 before synchronization loss, disabling RF transmission on RUs 116 that are connected to the DU 114 can be prevented. Additionally, disabling the transmission array carriers and the reception array carriers of the connected RUs 116 may be avoided. As a result, the degradation of network performance, increased latency, inaccurate resource scheduling, and disruption in the handover process in the wireless network due to synchronization failure in the DU 114 can be prevented.

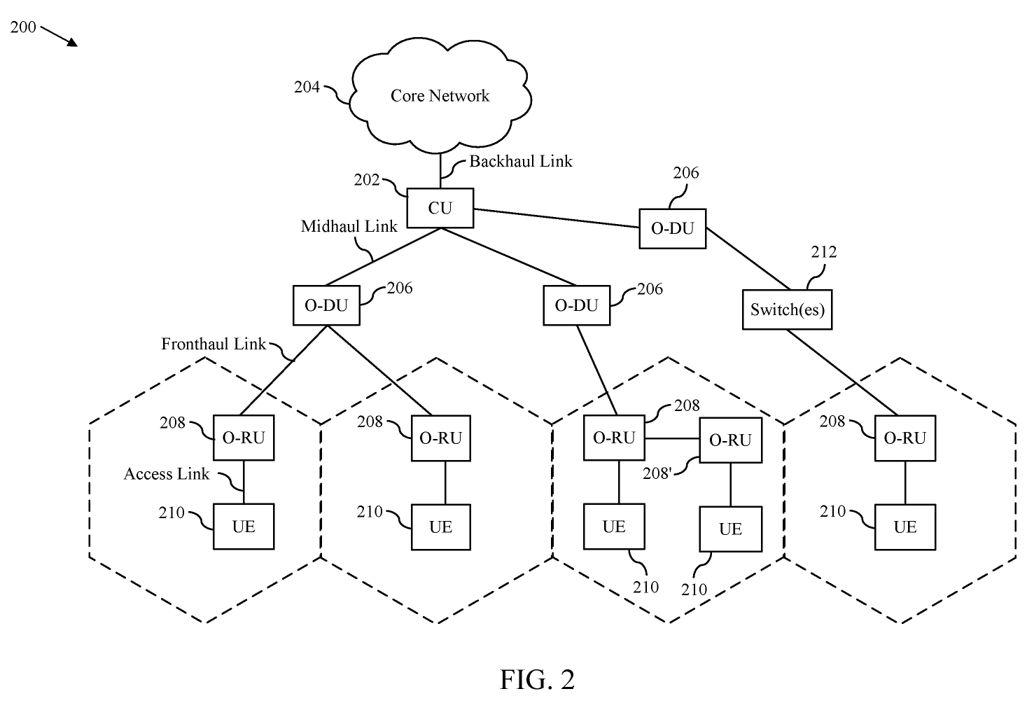

FIG. 2 is a diagram that illustrates an example of an Open Radio Access Network (O-RAN) architecture 200, in accordance with certain aspects of the present disclosure. In various aspects, the O-RAN architecture 200 may be implemented by one or more network nodes of the wireless communication system 100. In an example, the wireless communication system 100 may include a fourth-generation (4G) system, a fifth-generation (5G) system, future generations, or the like. For example, a network node of the network nodes may include a New Radio (NR) base station, a Long-Term Evolution (LTE) base station, a Node B, an eNB, a gNB, a Radio Access Network (RAN) node, an access point, a transmission-reception point (TRP), a mobile entity of a wireless communication network, or the like. In an example, the O-RAN architecture 200 may be correspond to disaggregated RAN architecture.

In various aspects, the O-RAN architecture 200 may include different network entities or nodes for wireless communication. For example, as shown in FIG. 2, the O-RAN architecture 200 may include a CU 202 (e.g., the CU 112) that is communicatively coupled to a core network 204 via a backhaul link (e.g., the backhaul link 122). In an example, the CU 202 may be implemented within the network node of the one or more network nodes. Further, the O-RAN architecture 200 may include one or more O-RAN DUs (O-DUs) 206 (e.g., the DU 114) and one or more O-RAN RUs (O-RUs) 208 (e.g., the RU 116). O-DUs 206 may be communicatively coupled to the CU 202 via a respective midhaul link (e.g., the midhaul link 124). Further, the O-DUs 206 may be communicatively coupled to at least one corresponding O-RU of the O-RUs 208 via at least one respective fronthaul link (e.g., the fronthaul link 126). The O-DUs 206 may be co-located with the CU 202, or alternatively, may be distributed across one or more different network nodes of the network nodes. The O-RUs 208 may be co-located with a corresponding O-DU of the O-DUs 206, or alternatively, may be distributed across a different network node of the network nodes. Further, the O-RUs 208 may be communicatively coupled to at least one corresponding UE 210 (e.g., UE 106) via a respective radio frequency (RF) access link. Examples of the UE 210 may include a cellular phone, a personal digital assistant (PDA) device, a wireless modem, a wireless communication device, a handheld device, a laptop computer, a wireless local loop (WLL) station, a tablet, a camera, a gaming device, a wearable device, or the like.

In various aspects, the CU 202 may host one or more higher-layer control functions for one or more of network control or signaling. In an example, the higher-layer control functions may include Radio Resource Control (RRC) functions, Packet Data Convergence Protocol (PDCP) functions, Service Data Adaptation Protocol (SDAP) functions, or the like. Each higher-layer control function of the higher-layer control functions may be implemented with an interface that is configured to communicate signals with remaining higher-layer control functions hosted by the CU 202. Further, the CU 202 may be configured to handle a user plane functionality (for example, a Central Unit-User Plane (CU-UP) functionality), a control plane functionality (for example, a Central Unit-Control Plane (CU-CP) functionality), or a combination thereof. In some aspects, the CU 202 may be logically split into one or more CU-UP units and one or more CU-CP units to handle the user plane functionality and the control plane functionality, respectively. In some more aspects, the CU 202 may be implemented to communicate with the O-DUs 206 for one or more of network control or signaling.

Each of the O-DUs 206 may correspond to a logical unit that includes one or more base station functions to control the operation of the corresponding O-RU of the O-RUs 208. In further aspects, each of the O-DUs 206 may host one or more of a Radio Link Control (RLC) layer, a Medium Access Control (MAC) layer, and one or more high-physical (high-PHY) layers depending, at least in part, on a functional split, such as a functional split defined by the 3rd Generation Partnership Project (3GPP). Further, each layer hosted by an O-DU 206 of the O-DUs 206 may be implemented with an interface that is configured to communicate signals with remaining layers hosted by the O-DU 206, or with the higher-layer control functions hosted by the CU 202. In some implementations, the O-DUs 206 may host the high-PHY layers for forward error correction (FEC) encoding and decoding, scrambling, or modulation and demodulation, for example.

Each of the O-RUs 208 may implement one or more lower-layer functionalities depending, at least in part, on the functional split defined by the 3GPP. The lower-layer functionalities may correspond to one or more low-physical (low-PHY) layer functions supported by a low-PHY layer or one or more RF processing functions. For example, the lower-layer functionalities may include performing a Fast Fourier Transform (FFT), performing an inverse Fast Fourier Transform (iFFT), digital beamforming, or Physical Random-Access Channel (PRACH) extraction and filtering, for example. In some aspects, each O-RU of the O-RUs 208 may be controlled by the corresponding O-DU of the O-DUs 206 to handle over-the-air (OTA) communication with the UE 210.

In the O-RAN architecture 200, synchronization of the network nodes enables seamless operation of wireless communication networks, including cellular services, private networks, industrial Internet of Things (IoT) applications, or the like. Synchronization may involve the O-DUs 206 and O-RUs 208, which shall operate in synchronization with each other to deliver reliable, high-performance wireless communication. The O-DUs 206 and O-RUs 208 may be synchronized with respect to at least one of frequency, phase, or time. Frequency synchronization may enable clocks of the O-DUs 206 and the O-RUs 208 to be aligned in frequency. Phase synchronization enables the clocks of the O-DUs 206 and the O-RUs 208 to be aligned in phase. Time synchronization may enable clocks of the O-DUs 206 and the O-RUs 208 to be aligned to a common base time.

In numerous aspects, one or more of synchronous Ethernet (SyncE) or Institute of Electrical and Electronics Engineers (IEEE) 1588 Precision Time Protocol (PTP) may be utilized for synchronization of O-DUs 206 and the O-RUs 208 in the wireless network. PTP is a precise time synchronization protocol used in packet-based networks (Ethernet, IP, etc.) to synchronize clocks of devices across the network. PTP may ensure that the network nodes can achieve sub-microsecond accuracy. A Primary Reference Time Clock (PRTC) may be utilized to implement PTP. The PRTC may correspond to a time source that provides the highest level of accuracy within a network and serves as the reference for time synchronization. In various examples, the PRTC may be connected to an external time source (for example, Global Navigation Satellite System (GNSS) such as Global Positioning System (GPS). In further examples, the PRTC may be remote or local to the network. PTP may allow the network nodes to synchronize their clocks to the PRTC (grand master clock), distributing accurate time across the network. SyncE may correspond to a synchronization protocol used in Ethernet networks, to distribute frequency synchronization. The PRTC may be further utilized to implement SyncE. In various examples, Physical layer frequency support (PLFS) may be employed for enabling frequency synchronization. PLFS may refer to the ability of the physical layer of a network to carry and support frequency synchronization signals.

In some aspects, a network node in the fronthaul may act as a Telecom Grand Master (T-GM). A T-GM may be located in the wireless network and may be configured to provide reference time and frequency to the wireless network. For example, the T-GM may correspond to a master clock in the wireless network. In some examples, the T-GM may be synchronized with the PRTC.

In various aspects, the O-DUs 206 and the O-RUs 208 may be synchronized using a synchronization topology of a plurality of synchronization topologies. The plurality of synchronization topologies may include Lower layer split-synchronization Configuration 1 (LLS-C1), LLS-C2, LLS-C3, and LLS-C4.

In LLS-C1, the O-DU 206 may be a part of a synchronization chain towards the O-RU 208. Further, network timing may be distributed from the O-DU 206 to the O-RU 208 via a direct connection between the O-DU 206 and the O-RU 208. Thus, synchronization data for the O-RU 208 may be distributed from the O-DU 206 via the direct connection. The O-DU 206 may directly synchronize the O-RU 208 in LLS-C1. Additionally, the O-DU 206 may be synchronized with a local or remote PRTC in LLS-C1. In various examples, the O-DU 206 may act as the T-GM in LLS-C1.

LLS-C2 may be similar to LLS-C1 with the O-DU 206 acting as the T-GM to distribute network timing towards O-RU 208. In LLS-C2, one or more ethernet switches (for example, switch(es) 212) may be coupled between the O-DU 206 and the O-RU 208. The coupled number of switches in the synchronization path may be limited by frequency and time error contributions by various clocks in the synchronization path. The O-RU 208 may receive the network timing from the O-DU 206 via the one or more ethernet switches.

In LLS-C3, the O-DU 206 may not be part of the synchronization chain towards the O-RU 208. Thus, the O-DU 206 may not be the T-GM in LLS-C3. Network timing may be distributed from a PRTC/T-GM to the O-DU 206 and the O-RU 208. In LLS-C3, one or more ethernet switches (for example, the switch(es) 212) may be allowed in the fronthaul network. In various examples, the one or more ethernet switches may be coupled to a PRTC and act as the T-GM.

In LLS-C4, a local PRTC may provide time synchronization to the O-RU 208 or a local PRTC/T-GM may provide synchronization to the O-RU 208 via a local PTP interface, or a local PRTC may be embedded in the O-RU 208. In LLS-C4, O-DU 206 may not be the T-GM for the O-RU 208.

In some aspects, one or more O-RUs (for example, an O-RU 208ˈ) may be cascaded to the O-RU 208 in the O-RAN architecture 200. In some aspects, the O-DU 206 may have to remain synchronized to a PRTC to enable various functions in the wireless network. Maintaining the O-DU 206 in synchronization with a PRTC is explained in conjunction with FIGS. 2 – 9.

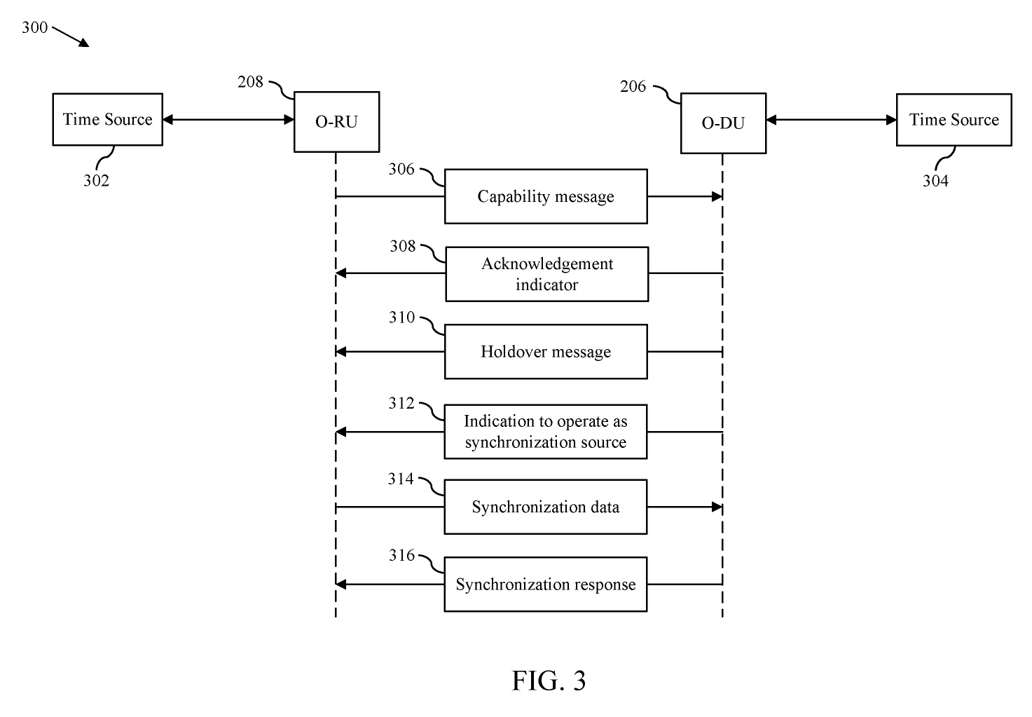

FIG. 3 is a diagram that illustrates an example of a message flow 300 between the O-DU 206 and the O-RU 208, in accordance with certain aspects of the present disclosure. FIG. 3 is explained in conjunction with FIGS. 1 and 2.

In various aspects, the O-RU 108 O-RU 208 may be coupled to a time source 302 and the O-DU 206 may be coupled to a time source 304. The time source 302 and the time source 304 may correspond to the PRTC. In some examples, the O-DU 206 may be synchronized with the time source 304. In an example, an internal clock of the O-DU 206 may be synchronized with the time source 304. The synchronization of the O-DU 206 with the time source 304 may enable the O-DU 206 to perform various functions in the wireless network. In some more examples, the O-RU 208 may be synchronized with the time source 302. In some additional examples, the O-RU 208 may be synchronized with the O-DU 206. For example, the O-DU 206 may be the T-GM in the fronthaul network. In numerous examples, a quality of the time source 302 may be the same as a quality of the time source 304.

In the aspects shown in FIG. 3, the message flow 300 may include transmitting a capability message 306. In various aspects, the O-RU 208 may be configured to transmit the capability message 306 to the O-DU 206. The O-DU 206 may be configured to receive the capability message 306 from the O-RU 208. The capability message 306 may indicate a capability of the O-RU 208 to operate as a synchronization source for the O-DU 206. The O-RU 208 may have the capability to operate as the synchronization source for the O-DU 206 based on the coupling of the O-RU 208 to the time source 302. For example, in a case where the O-RU 208 is coupled to a precise time source (e.g., the time source 302), the O-RU 208 can receive accurate timing information from the time source 302 and relay the received timing information to the O-DU 206 as per operational demands. Thus, the O-RU 208 may have the capability to operate as the synchronization source for the O-DU 206 based on the coupling to the time source 302. The capability of the O-RU 208 to operate as the synchronization source for the O-DU 206 may refer to a capability of the O-RU 208 to enable synchronization of the O-DU 206 with the time source 302. In an example, the capability of the O-RU 208 to operate as the synchronization source for the O-DU 206 may be represented by a flag in the capability message 306. For example, the flag may indicate a first configured value (e.g., a Boolean value of ‘1’) to specify that the O-RU 208 has the capability to operate as the synchronization source for the O-DU 206. Additionally, or alternatively, the flag may indicate a second configured value (e.g., a Boolean value of ‘0’) to specify that the O-RU 208 does not have the capability to operate as the synchronization source for the O-DU 206.

In some examples, the capability message 306 may be optionally indicative of a switch time-period of the O-RU 208. The switch time-period may refer to a time-period within which the O-DU 206 may be synchronized with the time source 302 in case of synchronization drift in the O-DU 206. For example, the switch time-period may correspond to a synchronization window usable for synchronization restoration, for example, in case of a synchronization drift in the O-DU 206. In various examples, the O-RU 208 may transmit the capability message 306 based on a power-ON of the O-RU 208, or restarting of the O-RU 208.

The message flow 300 may include transmission of an acknowledgment indicator 308. In various aspects, the O-DU 206 may be configured to transmit the acknowledgment indicator 308 to the O-RU 208. The O-RU 208 may be configured to receive the acknowledgment indicator 308 from the O-DU 206. The O-DU 206 may transmit the acknowledgment indicator 308 to the O-RU 208 in response to the reception of the capability message 306. In some examples, the O-DU 206 may acknowledge the capability of the O-RU 208 to operate as the synchronization source for the O-DU 206 by way of the acknowledgment indicator 308. In some more examples, the acknowledgment indicator 308 may specify that the O-DU 206 may utilize the capability of the O-RU 208 to operate as the synchronization source for the O-DU 206 under suitable conditions.

In some aspects, the O-DU 206 may be configured to detect synchronization drift in the O-DU 206. In some examples, the O-DU 206 may detect one or more of frequency or time accuracy degradation in the internal clock of the O-DU 206. Such frequency or time accuracy degradation in the internal clock may correspond to the synchronization drift in the O-DU 206. In various examples, the synchronization drift may be caused by at least one of a failure of the time source 304, connection loss between the O-DU 206 and the time source 304, or the like. In numerous examples, the O-DU 206 may be referred to as being in a HOLDOVER state when the synchronization drift occurs in the O-DU 206.

In some more aspects, the O-DU 206 may be configured to generate a holdover message 310 based on the detection of the synchronization drift in the O-DU 206. The holdover message 310 may indicate the detected synchronization drift in the O-DU 206. In various examples, the O-DU 206 may be associated with a holdover expiration time-period. The synchronization of the O-DU 206 with the time source 304 may be lost after completion of the holdover expiration time-period. In some examples, the holdover expiration time-period may begin upon the detection of the synchronization drift in the O-DU 206. The holdover expiration time-period may refer to the time duration for which the O-DU 206 can maintain acceptable synchronization after losing connection to the time source 304. The holdover expiration time-period may represent the time taken for synchronization drift to accumulate to a value at which the O-DU 206 can no longer function within a configured timing accuracy, ultimately leading to the loss of synchronization. In further examples, the holdover expiration time-period may be longer than the switch time-period.

The message flow 300 may include transmission of the holdover message 310. In various aspects, the O-DU 206 may be configured to transmit the holdover message 310 to the O-RU 208. The O-RU 208 may be configured to receive the holdover message 310 from the O-DU 206. In some examples, the O-DU 206 may transmit the holdover message 310 based on (e.g., in response to) the detection of the synchronization drift in the O-DU 206. In further examples, the holdover message 310 may be transmitted prior to the completion of the holdover expiration time-period.

In some aspects, based on the reception of the holdover message 310, the O-RU 208 may be configured to perform a set of configured operations that may enable the O-RU 208 to operate as the synchronization source for the O-DU 206. In some examples, the O-RU 208 may synchronize an internal clock of the O-RU 208 with the time source 302 upon the reception of the holdover message 310 while the O-DU 206 is still the T-GM for the O-RU 208.

As shown in FIG. 3, the message flow 300 may include transmission of an indication 312 to operate as the synchronization source. In various aspects, the O-DU 206 may be configured to transmit to the O-RU 208, the indication 312 to operate as the synchronization source for the O-DU 206. The O-DU 206 may transmit to the O-RU 208, the indication 312 to operate as the synchronization source for the O-DU 206 based on the detection of the synchronization drift in the O-DU 206. The O-RU 208 may be configured to receive, from the O-DU 206, the indication 312 to operate as the synchronization source for the O-DU 206, in response to the synchronization drift in the O-DU 206. In an example, the transmitted indication may be associated with the synchronization drift in the O-DU 206. For example, the indication may be transmitted in response to the synchronization drift in the O-DU 206.

In some aspects, the transmission of the indication 312 to operate as the synchronization source for the O-DU 206 may be based on the capability message 306 when the capability message indicates that the O-RU 208 is capable of operating as the synchronization source for the O-DU. Thus, the O-DU 206 may transmit, to the O-RU 208, the indication 312 to operate as the synchronization source for the O-DU 206 based on the capability message 306 indicating the capability of the O-RU 208 to operate as the synchronization source for the O-DU 206. The indication 312 to operate as the synchronization source may be alternatively referred to as “the indication 312”.

In numerous aspects, the O-RU 208 may be configured to operate as the synchronization source for the O-DU 206 based on the indication 312. In various examples, the operation of the O-RU 208 as the synchronization source for the O-DU 206 may include configuring the O-RU 208 as the T-GM for the O-DU 206. In various examples, the O-RU 208 may be configured to generate synchronization data 314 based on the time source 302 to operate as the synchronization source for the O-DU 206. In further examples, the O-RU 208 may be configured to receive the synchronization data 314 from the time source 302 for operating as the synchronization source for the O-DU 206. The synchronization data 314 may associated with at least one of a network timing, a network frequency, or a network phase.

The message flow 300 may include transmission of the synchronization data 314. In various aspects, the O-RU 208 may be configured to transmit the synchronization data 314 to the O-DU 206 in response to the indication 312. The O-DU 206 may be configured to receive the synchronization data 314 from the O-RU 208 in response to the transmission of the indication 312. In various examples, the synchronization data 314 may be transmitted via a 1 pulse per second (PPS)/time of day (ToD) interface in the fronthaul link. In further examples, the synchronization data 314 may include at least one of one or more PTP packets, one or more SyncE signals, or the like. PTP packets may include timestamps that allow slaves to calculate offset and delay between the slaves and the master clock. SyncE signals may refer to frequency reference signals. A SyncE signal may be embedded in an Ethernet frame, such as in synchronization and frequency information fields of the Ethernet frame.

In many aspects, the O-DU 206 may be configured to restore synchronization in the O-DU 206 based on the synchronization data 314. For example, the O-DU 206 may synchronize the internal clock with the O-RU 208 based on the synchronization data 314. As a result, the O-DU 206 may be synchronized with the time source 302. In various examples, the restoration of the synchronization of the O-DU 206 may include the following operations. The O-DU 206 may calculate a time offset between the internal clock and the O-RU 208 based on the synchronization data 314. Further, the O-DU 206 may transmit a delay request packet to the O-RU 208 to measure network delay between the O-DU 206 and the O-RU 208. In response to the delay request packet, the O-DU 206 may receive a delay response packet that is indicative of a timestamp of a reception of the delay request packet by the O-RU 208. Further, the O-DU 206 may determine round-trip time and compensate for delays based on the determined round-trip time. Thus, the internal clock of the O-DU 206 may be synchronized with the O-RU 208, thus restoring the synchronization in the O-DU 206. In an example, the restoration of the synchronization in the O-DU 206 may be with respect to at least one of the time, the phase, or the frequency, for example, indicated in the synchronization data 314.

In numerous aspects, the O-DU 206 may be configured to restore the synchronization in the O-DU 206 based on the synchronization data 314 within the switch time-period after the detection of the synchronization drift. As described previously, the switch time-period may be less than the holdover expiration time-period associated with the O-DU 206. Thus, the O-DU 206 may be synchronized with the O-RU 208 before loss of synchronization between the O-DU 206 and the time source 304. For example, the synchronization in the O-DU 206 may be restored before the O-DU 206 runs into a FREERUN state where data transmission associated with the O-DU 206 is halted. Thus, switching of the O-RU 208 as the T-GM in the fronthaul network prevents disabling of RF transmission on O-RUs that are connected to the O-DU 206. Additionally, disabling of the transmission array carriers and the reception array carriers of the O-RU 208 may be avoided. As a result, the degradation of network performance, increased latency, inaccurate resource scheduling, and disruption in the handover process in the wireless network due to synchronization failure in the O-DU 206 may be prevented. Thus, the disclosed aspects result in improved network reliability in the O-RAN architecture 200.

The message flow 300 may include transmission of a synchronization response 316. In various aspects, the O-DU 206 may be configured to transmit the synchronization response 316 to the O-RU 208 based on the restoration of the synchronization in the O-DU 206. In an example, the synchronization response 316 may indicate that the O-DU 206 is synchronized with the O-RU 208. In some aspects, the O-RU 208 may be configured to receive the synchronization response 316 from the O-DU 206 based on the restoration of the synchronization in the O-DU 206. In various examples, transmission of the capability message 306, the acknowledgment indicator 308, the holdover message 310, and the synchronization response 316 may be optional.

In various optional aspects, the O-RU 208 may be configured to transmit the synchronization data 314 to the one or more additional O-RUs (for example, the O-RU 208ˈ) that are cascaded to the O-RU 208 based on the operation of the O-RU 208 as the synchronization source. In some aspects, the one or more additional O-RUs may be synchronized with the O-DU 206. In such aspects, synchronization loss in the O-DU 206 may lead to cascaded synchronization loss in the one or more additional O-RUs. The one or more additional O-RUs may be synchronized with the O-RU 208 based on the synchronization data 314, thereby eliminating disabling of RF transmission on the one or more additional O-RUs and disabling of the transmission array carriers and the reception array carriers of the one or more additional O-RUs.

In numerous aspects, at least one of the capability message 306, the acknowledgment indicator 308, the holdover message 310, the indication 312, the synchronization data 314, or the synchronization response 316 may correspond to a management plane (M-plane) message. In further aspects, the synchronization data 314 may correspond to a synchronization plane (S-plane) message.

In numerous additional aspects, the O-RU 208 may be determined to be eligible to operate as the synchronization source for the O-DU 206 based on an execution of a best master clock algorithm (BMCA) in the O-RAN architecture 200. The BMCA may take into consideration, at least one of a clock class, clock accuracy, clock priority, and the time source 302 associated with the O-RU 208 to determine that the O-RU 208 is eligible to operate as the synchronization source for the O-DU 206.

In further aspects, the O-DU 206 may include a Functional Application Platform Interface (FAPI). In numerous examples, the FAPI may correspond to an interface, defined by Small Cell Forum (SCF), that enables communication between the MAC layer and the physical layer in the wireless communication system 100. In some examples, the FAPI may include a plurality of interfaces, with each interface serving a specific role to enable communication between the MAC layer and the physical layer. The plurality of interfaces may include a P4 interface, a P5 interface, a P7 interface, or a P19 interface. The P4 interface may enable network monitoring across multiple generations, such as 4G, 5G, or the like, enabling spectrum analysis and management. The P5 interface may support the physical layer configurations, enabling the small cell to be operational. The P7 interface may support the transmission of per-slot messages or per-subframe messages, enabling the OTA communication. The P19 interface may support network virtualization, enabling a dynamic control for a Frontend Unit (FEU), such as a Digital Front End (DFE) and an Analog Beamforming (ABF). As the O-DU 206 may be synchronized with the O-RU 208 upon the detection of the synchronization drift in the internal clock, the control plane/user plane traffic can continue with the physical layer via the P7 interface of the FAPI.

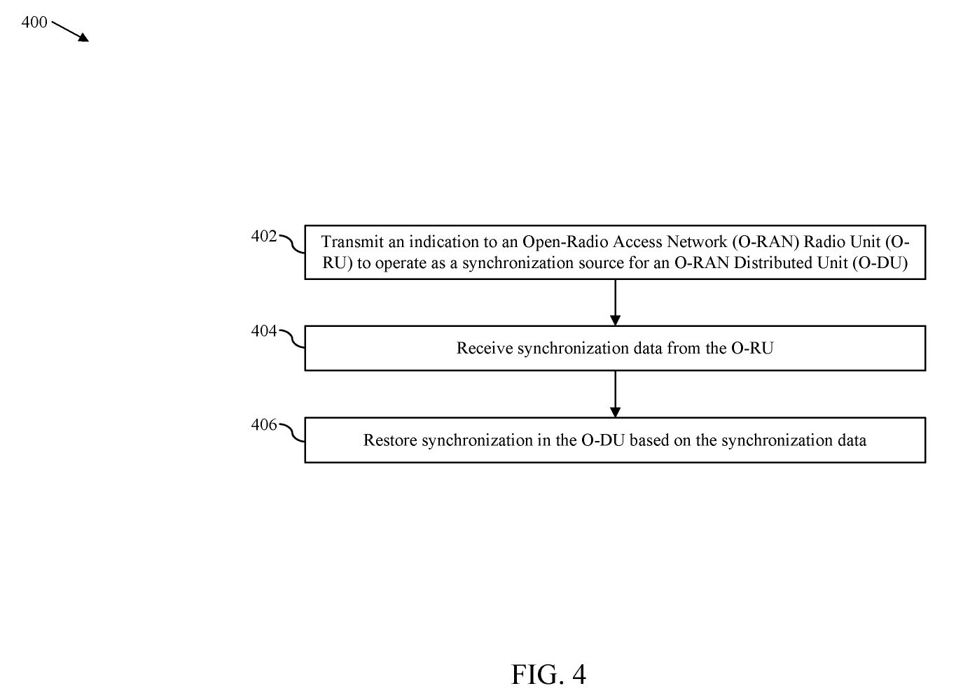

FIG. 4 is a diagram that illustrates a high-level flowchart for a synchronization process (e.g., a method) 400, in accordance with certain aspects of the present disclosure. FIG. 4 is explained in conjunction with FIGS. 1, 2, and 3. In various examples, the process 400 may be implemented by the O-DU 206 to enable Grand Master switching for fronthaul synchronization. Grand Master switching may refer to dynamically selecting and switching between Grand Master Clocks to maintain network timing synchronization. In example, Grand Master switching may refer to Grand Master Clock switching.

At 402, the O-DU 206 may transmit the indication 312 to operate as the synchronization source for the O-DU 206 to the O-RU 208. In an example, the indication may be associated with a synchronization drift in the O-DU 206 as described in the foregoing description of FIG. 3.

At 404, the O-DU 206 may receive the synchronization data 314 from the O-RU 208. The synchronization data 314 may include at least one of the network timing, the network frequency, or the network phase. In an example, the synchronization data 314 may be received in response to the transmission of the indication 312.

At 406, the O-DU 206 may restore the synchronization in the O-DU 206 based on the synchronization data 314. In some aspects, the O-DU 206 may restore the synchronization with respect to at least one of time, phase, or frequency. As a result, the O-DU 206 may be prevented from being out of synchronization.

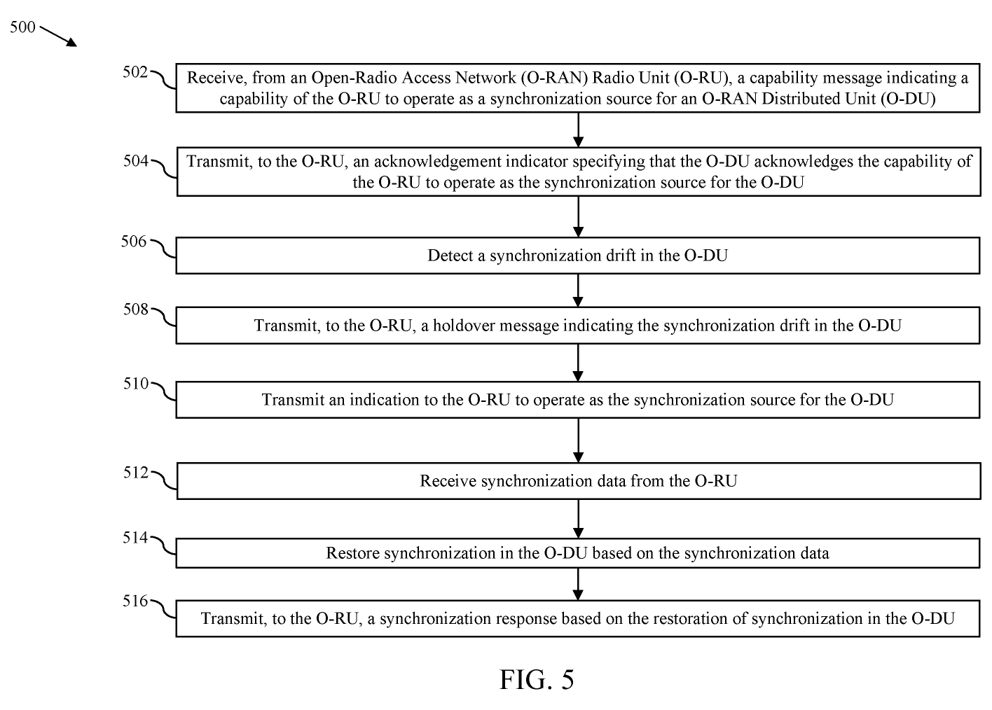

FIG. 5 is a diagram that illustrates a flowchart for a synchronization process (e.g., a method) 500, in accordance with certain aspects of the present disclosure. FIG. 5 is explained in conjunction with FIGS. 1, 2, and 3. In various examples, the process 500 may be implemented by the O-DU 206 to enable Grand Master switching for fronthaul synchronization. Grand Master switching may refer to dynamically replacing an existing Grand Master Clock with a different Grand Master Clock to sustain network timing synchronization.

At 502, the O-DU 206 may receive the capability message 306 indicating the capability of the O-RU 208 to operate as the synchronization source for the O-DU 206 from the O-RU 208. In some examples, the capability message 306 may be received based on the power ON or restarting of the O-RU 208. In further examples, the O-DU 206 may receive the capability message 306 via the fronthaul link. In furthermore examples, the capability message 306 may be further indicative of the switch time-period. In an example, the switch time-period may correspond to a synchronization window usable for synchronization restoration.

At 504, the O-DU 206 may transmit the acknowledgment indicator 308 specifying that the O-DU 206 acknowledges the capability of the O-RU 208 to operate as the synchronization source for the O-DU 206. In various aspects, the acknowledgment indicator 308 may be transmitted based on the received capability message 306.

At 506, the O-DU 206 may detect the synchronization drift in the O-DU 206. In some examples, the synchronization drift in the O-DU 206 may be detected based on the one or more of frequency or the time accuracy degradation in the internal clock. The O-DU 206 may be synchronized with the time source 304 and the synchronization drift may refer to the O-DU 206 drifting away from the time source 304.

At 508, the O-DU 206 may transmit the holdover message 310 indicating the synchronization drift to the O-RU 208. In various examples, the holdover message 310 may be transmitted to the O-RU 208 via the fronthaul link.

At 510, the O-DU 206 may transmit the indication 312 to operate as the synchronization source for the O-DU 206 to the O-RU 208. The indication 312 may be associated with the synchronization drift. For example, the indication 312 may be transmitted to the O-RU 208 in response to the synchronization drift in the O-DU 206. In some examples, the indication 312 may be transmitted to the O-RU 208 based on the capability message 306 received from the O-RU 208. In some more examples, the indication 312 may be transmitted to the O-RU 208 via the fronthaul link. Thus, an indication for Grand Master switching for fronthaul synchronization is transmitted to the O-RU 208.

At 512, the O-DU 206 may receive the synchronization data 314 from the O-RU 208. The synchronization data 314 may include at least one of the network timing, the network frequency, or the network phase. In numerous aspects, the O-DU 206 may receive the synchronization data 314 based on the Grand Master switching. In some examples, the synchronization data 314 may be received via an M-plane message. In some more examples, the synchronization data 314 may be received via an S-plane message.

At 514, the O-DU 206 may restore synchronization in the O-DU 206 based on the synchronization data 314. For example, the O-DU 206 may synchronize the internal clock with the time source 302 associated with the O-RU 208 based on the synchronization data 314, which in turn restores synchronization in the O-DU 206. In numerous examples, the synchronization in the O-DU 206 may be restored within the switch time-period from the detection of the synchronization drift. Thus, fronthaul synchronization based on Grand Master switching may be achieved. Further, the O-DU 206 may be prevented from being out of synchronization.

At 516, the O-DU 206 may transmit the synchronization response 316 to the O-RU 208 based on the restoration of the synchronization in the O-DU 206. In various examples, the synchronization response 316 may indicate that the O-DU 206 is synchronized with the O-RU 208.

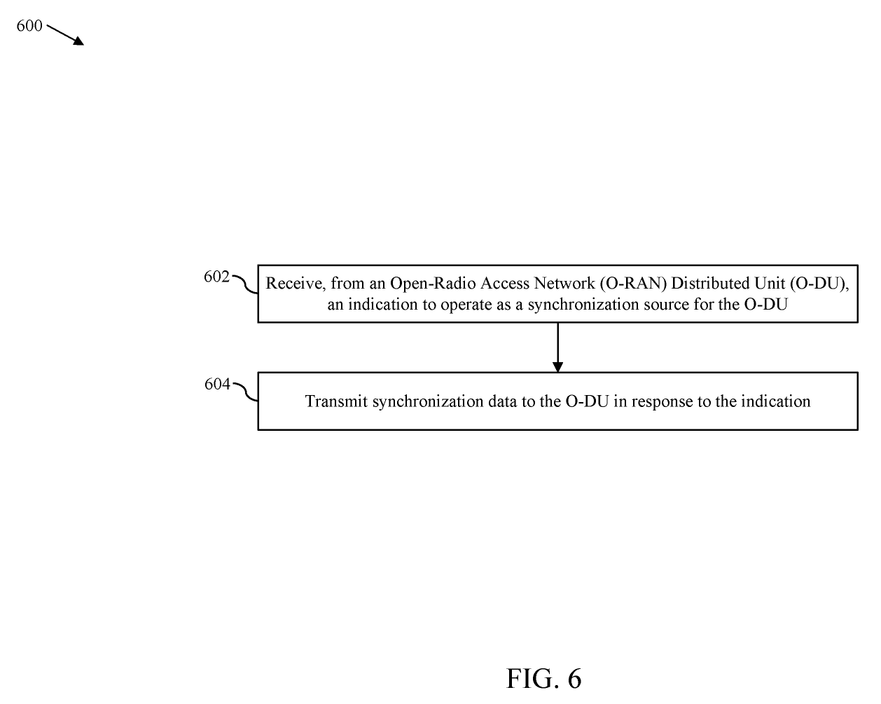

FIG. 6 is a diagram that illustrates a high-level flowchart for a process (e.g., a method) 600 for executing Grand Master switching for fronthaul synchronization, in accordance with certain aspects of the present disclosure. FIG. 6 is explained in conjunction with FIGS. 1, 2, and 3. In various examples, the process 600 may be implemented by the O-RU 208.

At 602, the O-RU 208 may receive the indication 312 to operate as the synchronization source for the O-DU 206 from the O-DU 206. In some examples, the indication 312 may be received based on (e.g., responsive to) a synchronization drift in the O-DU 206. In many examples, the O-RU 208 may operate as the synchronization source based on the received indication 312. In more examples, the O-RU 208 may operate as the master clock for the O-DU 206. Thus, the Grand Master switching for fronthaul synchronization is enabled.

At 604, the O-RU 208 may transmit the synchronization data 314 to the O-DU 206 in response to the indication 312. In various examples, the restoration of synchronization in the O-DU 206 may be based on the synchronization data 314. Thus, the Grand Master switching for fronthaul synchronization is executed.

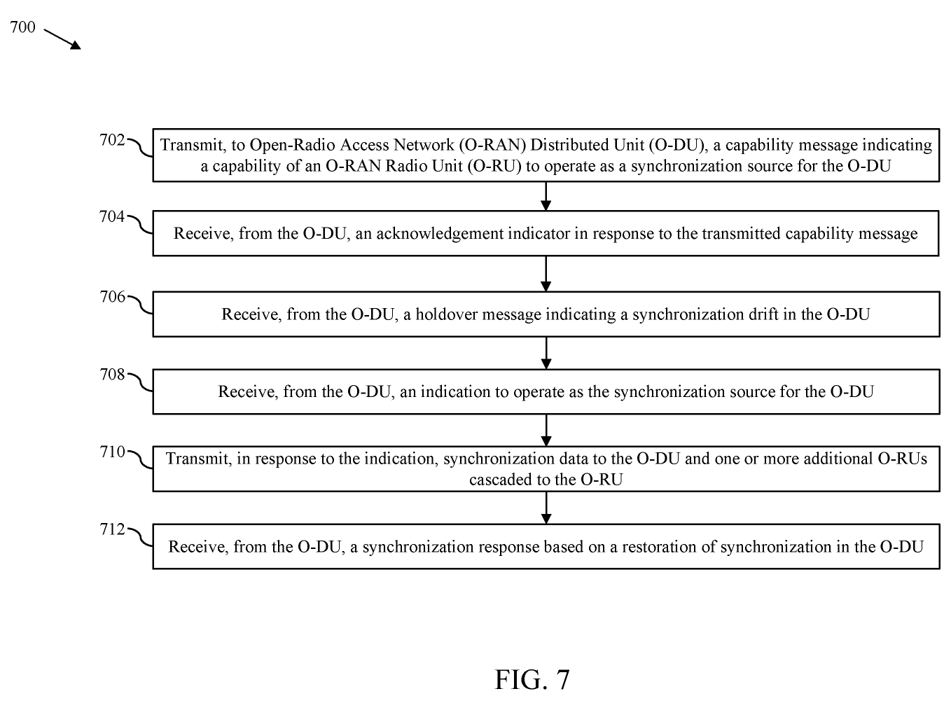

FIG. 7 is a diagram that illustrates a flowchart for a process (e.g., a method) 700 for executing Grand Master switching for fronthaul synchronization, in accordance with certain aspects of the present disclosure. FIG. 7 is explained in conjunction with FIGS. 1, 2, and 3. In various examples, the process 700 may be implemented by the O-RU 208.

At 702, the O-RU 208 may transmit the capability message 306 indicating the capability of the O-RU 208 to operate as the synchronization source for the O-DU 206 to the O-DU 206. In some examples, the capability message 306 may be transmitted based on the power ON or restarting of the O-RU 208. In further examples, the O-RU 208 may transmit the capability message 306 via the fronthaul link. In more examples, the capability message 306 may be further indicative of the switch time-period. In an example, the switch time-period may correspond to a synchronization window usable or configured for synchronization restoration by the O-RU 208.

At 704, the O-RU 208 may receive the acknowledgment indicator 308 from the O-DU 206 in response to the transmitted capability message 306.

At 706, the O-RU 208 may receive the holdover message 310 indicating the synchronization drift in the O-DU 206 from the O-DU 206. In various examples, the holdover message 310 may be received from the O-DU 206 via the fronthaul link.

At 708, the O-RU 208 may receive the indication 312 to operate as the synchronization source for the O-DU 206, from the O-DU 206. In some examples, the indication 312 may be associated with a synchronization drift in the O-DU 206. In an example, based on the received indication 312, the O-RU 208 may operate as the synchronization source for the O-DU 206. Thus, the Grand Master switching for fronthaul synchronization is enabled.

At 710, the O-RU 208 may transmit the synchronization data 314 to the O-DU 206 and the one or more additional O-RUs 208’ cascaded to the O-RU 208 in response to the indication. In various examples, the O-DU 206 and the one or more additional O-RUs 208’ cascaded to the O-RU 208 may be synchronized with the O-RU 208 based on the synchronization data 314. Thus, the Grand Master switching for fronthaul synchronization is executed.

At 712, the O-RU 208 may receive the synchronization response 316 from the O-DU 206 based on the restoration of synchronization in the O-DU 206. In various examples, the synchronization response 316 may indicate that the O-DU 206 is synchronized with the O-RU 208.

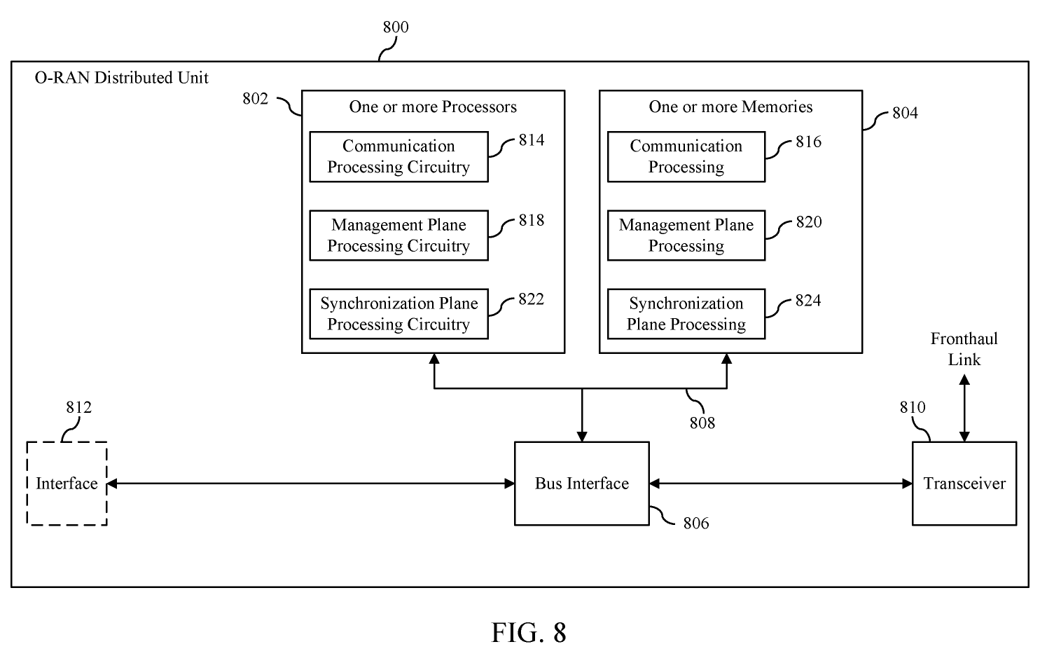

FIG. 8 is a diagram that illustrates an example of an O-DU 800, in accordance with certain aspects of the present disclosure. FIG. 8 is explained in conjunction with FIGS. 1 – 7. The O-DU 800 may enable wireless communication with one or more of an O-RU or one or more communication devices. In some examples, the O-DU 800 may correspond to the NR base station, the LTE base station, the eNB, the gNB, the access point, the TRP, or the like.

In some aspects, the O-DU 800 may include one or more processors 802, one or more memories 804, a bus interface 806, a bus 808, and a transceiver 810. Examples of the one or more processors 802 may include microprocessors, microcontrollers, digital signal processors (DSPs), field programmable gate arrays (FPGAs), programmable logic devices (PLDs), state machines, gated logic, discrete hardware circuits, or suitable hardware configured to perform the various functionality described throughout this disclosure. In various examples, the O-DU 800 may be configured to perform one or more of the functions described in FIGS. 1 – 7. That is, the one or more processors 802, as utilized in the O-DU 800, may be used to implement one or more of the processes and procedures described in FIGS. 1 – 7.

The one or more processors 802 may in some instances be implemented via a baseband or modem chip and in additional implementations, the one or more processors 802 may comprise a number of devices distinct and different from a baseband or modem chip. And as mentioned above, various hardware arrangements and components outside of a baseband modem processor can be used in implementations, including RF-chains, power amplifiers, modulators, buffers, interleavers, adders/summers, etc.

The one or more memories 804 may include one or more of suitable circuitry, interfaces, or logic configured to store instructions (e.g., computer-executable code) that when executed by the one or more processors 802 may cause the one or more processors 802 to perform the operations illustrated in FIGS. 1 – 7, or additional operations to enable Grand Master switching for fronthaul synchronization. The O-DU 800 may store data within the one or more memories 804 by transforming the physical state of one or more physical storage units (e.g., transistors, magnetic domains, optical pits, gate cells, phase change materials, etc.) in the one or more memories 804 to reflect the information being stored. The specific transformation of physical state can depend on various factors. Examples of such factors can include, but are not limited to, the technology used to implement the physical storage units, whether the one or more memories 804 is characterized as primary or secondary storage, and the like.

In further aspects, the one or more memories 804 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a RAM, a ROM, a PROM, an EPROM, an EEPROM, a register, a removable disk, and any suitable medium for storing one or more of software or instructions that may be accessed and read by a computer.

In numerous examples, the O-DU 800 may be implemented with a bus architecture, represented generally by the bus 808. The bus 808 may include one or more interconnecting buses or bridges based on the specific application of the O-DU 800 and the overall design constraints. The bus 808 may communicatively couple various circuits including the one or more processors 802, the one or more memories 804, and the bus interface 806. In some examples, bus 808 may also link various circuits such as timing sources, peripherals, voltage regulators, and power management circuits, that are well known in the art, and therefore, will not be described any further.

In some aspects, the bus interface 806 may provide an interface between the bus 808 and the transceiver 810. In some more aspects, the O-DU 800 may further include an interface 812. The transceiver 810 may provide a communication interface or means for communicating with various apparatus over a wireless transmission medium. In some additional examples, the O-DU 800 may include two or more transceivers, each configured to communicate with a respective network type (e.g., terrestrial or non-terrestrial). The interface 812 may provide a communication interface or means of communicating with various apparatuses and devices (e.g., devices housed within the same apparatus as the O-DU 800 or external apparatuses) over an internal bus or external transmission medium, such as an Ethernet cable. Depending upon the nature of the apparatus, the interface 812 may optionally include a user interface.

The one or more processors 802 may be responsible for managing the bus 808 and general processing, including the execution of software stored on the one or more memories 804. The software, when executed by the one or more processors 802, may cause the one or more processors 802 to perform the various functions described in FIGS. 1 – 7. In some examples, the one or more memories 804 may be used for storing data that is manipulated by the one or more processors 802 when executing the software. In some implementations, the one or more processors 802 and the one or more memories may constitute the processing system 136.

In numerous examples, the software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In numerous aspects, the one or more processors 802 may include circuitry configured for various functions. The one or more processors 802 may include communication processing circuitry 814. The communication processing circuitry 814 may be configured to communicate with an O-RU (for example, the O-RU 208) via the transceiver 810 and a fronthaul link.

In various aspects, the communication processing circuitry 814 may obtain information from a component of the O-DU 800 (for example, from the transceiver 810 that receives the information via radio frequency signaling or some type of signaling suitable for the applicable communication medium), process (for example, decode) the information, and output the processed information. For example, the communication processing circuitry 814 may output the information to a different component of the one or more processors 802, to the one or more memories 804, or to the bus interface 806. In some examples, the communication processing circuitry 814 may receive one or more of signals, messages, information, or any combination thereof. In some examples, the communication processing circuitry 814 may receive information via one or more channels. In some examples, the communication processing circuitry 814 may include functionality for a means for receiving.

In some aspects, the communication processing circuitry 814 may obtain information (for example, from a different component of the one or more processors 802, the one or more memories 804, or the bus interface 806), process (for example, encode) the information, and output the processed information. For example, the communication processing circuitry 814 may output the information to the transceiver 810. In some examples, the communication processing circuitry 814 may transmit information via one or more channels. In some examples, the communication processing circuitry 814 may include functionality for a means for transmitting. In various examples, the communication processing circuitry 814 may further be configured to execute communication processing software 816 included on the one or more memories 804 to implement one or more functions described herein.

In numerous additional aspects, the one or more processors 802 may include management plane processing circuitry 818 configured to perform management plane processing-related operations as discussed herein (for example, receiving the capability message 306 and processing the capability message 306 to determine capabilities of the O-RU 208). The management plane processing circuitry 818 may further be configured to execute management plane processing software 820 included on the one or more memories 804 to implement one or more functions described herein.

In various aspects, the one or more processors 802 may include synchronization plane processing circuitry 822 configured to perform synchronization plane processing-related operations as discussed herein (for example, receiving the synchronization data 314, restoring the synchronization in the O-DU 800, or the like). The synchronization plane processing circuitry 822 may further be configured to execute synchronization plane processing software 824 included on the one or more memories 804 to implement one or more functions described herein.

In some implementations, the O-DU 800 may be configured to operate as the O-DU 206, described herein. In some more implementations, the O-DU 206 described herein may correspond to (or may be included in) the O-DU 800. For example, the one or more processors 802 or any remaining components of the O-DU 800 may enable the O-DU 800 to perform the operations of one or more processes (for example, the processes 400 and 500) described herein.

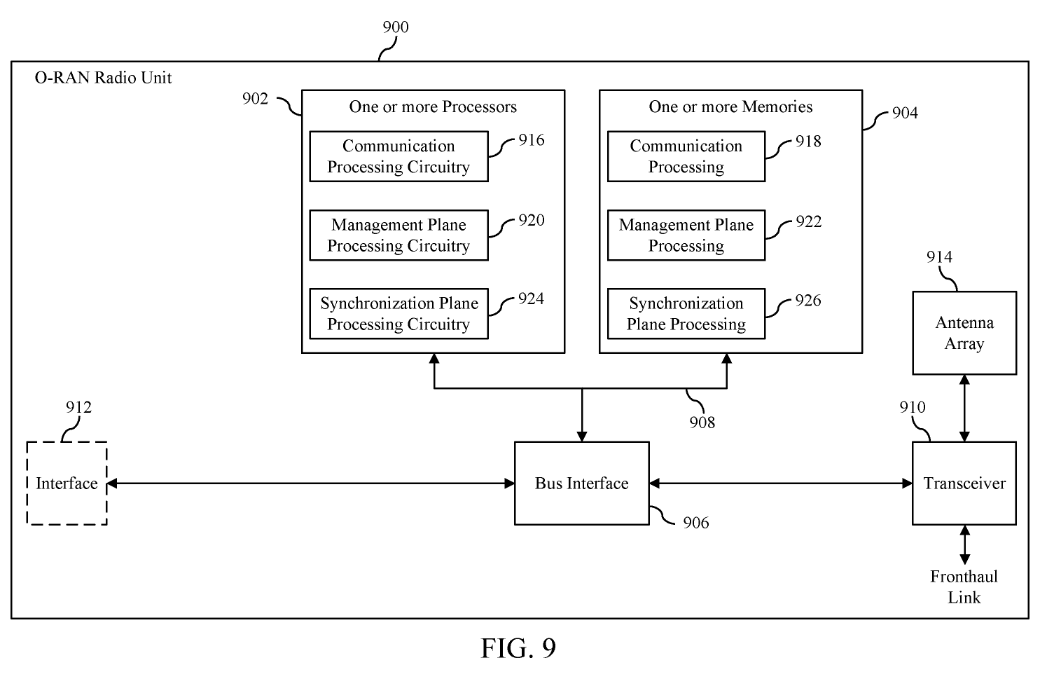

FIG. 9 is a diagram that illustrates an example of an O-RU 900, in accordance with certain aspects of the present disclosure. FIG. 9 is explained in conjunction with FIGS. 1 – 7. The O-RU 900 may enable wireless communication with one or more of an O-DU or one or more communication devices (for example, UEs). In some examples, the O-RU 900 may correspond to the NR base station, the LTE base station, the eNB, the gNB, the access point, the TRP, or the like.

In some aspects, the O-RU 900 may include one or more processors 902, one or more memories 904, a bus interface 906, a bus 908, and a transceiver 910. Examples of the one or more processors 902 may include microprocessors, microcontrollers, digital signal processors (DSPs), field programmable gate arrays (FPGAs), programmable logic devices (PLDs), state machines, gated logic, discrete hardware circuits, or suitable hardware configured to perform the various functionalities described throughout this disclosure. In various examples, the O-RU 900 may be configured to perform one or more of the functions described in FIGS. 1 – 7. That is, the one or more processors 902, as utilized in the O-RU 900, may be used to implement one or more of the processes and procedures described in FIGS. 1 – 7.

The one or more processors 902 may in some instances be implemented via a baseband or modem chip and in additional implementations, the one or more processors 902 may itself comprise a number of devices distinct and different from a baseband or modem chip (e.g., in such scenarios as may work in concert to achieve embodiments discussed herein). And as mentioned above, various hardware arrangements and components outside of a baseband modem processor can be used in implementations, including RF-chains, power amplifiers, modulators, buffers, interleavers, adders/summers, etc.

The one or more memories 904 may include one or more of suitable circuitry, interfaces, or logic configured to store instructions (e.g., computer-executable code) that when executed by the one or more processors 902 may cause the one or more processors 902 to perform the operations illustrated in FIGS. 1 – 7, or additional operations to optimize channel information signaling in fronthaul interface. The O-RU 900 may store data within the one or more memories 904 by transforming the physical state of one or more physical storage units (e.g., transistors, magnetic domains, optical pits, gate cells, phase change materials, etc.) in the one or more memories 904 to reflect the information being stored. The specific transformation of physical state can depend on various factors. Examples of such factors can include, but are not limited to, the technology used to implement the physical storage units, whether the one or more memories 904 is characterized as primary or secondary storage, and the like.

In further aspects, the one or more memories 904 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a RAM, a ROM, a PROM, an EPROM, an EEPROM, a register, a removable disk, and any suitable medium for storing one or more of software or instructions that may be accessed and read by a computer.

In numerous examples, the O-RU 900 may be implemented with a bus architecture, represented generally by the bus 908. The bus 908 may include one or more interconnecting buses or bridges based on the specific application of the O-RU 900 and the overall design constraints. The bus 908 may communicatively couple various circuits including the one or more processors 902, the one or more memories 904, and the bus interface 906. In some examples, bus 908 may also link various circuits such as timing sources, peripherals, voltage regulators, and power management circuits, that are well known in the art, and therefore, will not be described any further.

In some aspects, the bus interface 906 may provide an interface between the bus 908 and the transceiver 910. In some more aspects, the O-RU 900 may further include an interface 912. The transceiver 910 may provide a communication interface or means for communicating with various apparatus over a wireless transmission medium. In some additional examples, the O-RU 900 may include two or more transceivers, each configured to communicate with a respective network type (e.g., terrestrial or non-terrestrial). The interface 912 may provide a communication interface or means of communicating with various apparatuses and devices (e.g., devices housed within the same apparatus as the O-RU 900 or external apparatuses) over an internal bus or external transmission medium, such as an Ethernet cable. Depending upon the nature of the apparatus, the interface 912 may optionally include a user interface.

The one or more processors 902 may be responsible for managing the bus 908 and general processing, including the execution of software stored on the one or more memories 904. The software, when executed by the one or more processors 902, may cause the one or more processors 902 to perform the various functions described in FIGS. 1 – 7. In some examples, the one or more memories 904 may be used for storing data that is manipulated by the one or more processors 902 when executing the software. In some implementations, the one or more processors 902 and the one or more memories 904 may constitute the processing system 138.

In numerous examples, the software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In numerous aspects, the one or more processors 902 may include circuitry configured for various functions. The one or more processors 902 may include communication processing circuitry 916. In some examples, the communication processing circuitry 916 may be configured to communicate with a UE (for example, the UE 210) via the transceiver 910 and an antenna array 914. In some more examples, the communication processing circuitry 916 may be configured to communicate with a O-DU (for example, the O-DU 206) via the transceiver 910 and a fronthaul link.

In various aspects, the communication processing circuitry 916 may obtain information from a component of the O-RU 900 (for example, from the transceiver 910 that receives the information via radio frequency signaling or some type of signaling suitable for the applicable communication medium), process (for example, decode) the information, and output the processed information. For example, the communication processing circuitry 916 may output the information to a different component of the one or more processors 902, to the one or more memories 904, or to the bus interface 906. In some examples, the communication processing circuitry 916 may receive one or more of signals, messages, information, or any combination thereof. In some examples, the communication processing circuitry 916 may receive information via one or more channels. In some examples, the communication processing circuitry 916 may include functionality for a means for receiving.

In some aspects, the communication processing circuitry 916 may obtain information (for example, from a different component of the one or more processors 902, the one or more memories 904, or the bus interface 906), process (for example, encode) the information, and output the processed information. For example, the communication processing circuitry 916 may output the information to the transceiver 910. In some examples, the communication processing circuitry 916 may transmit information via one or more channels. In some examples, the communication processing circuitry 916 may include functionality for a means for transmitting. In various examples, the communication processing circuitry 916 may further be configured to execute communication processing software 918 included on the one or more memories 904 to implement one or more functions described herein.

In numerous additional aspects, the one or more processors 902 may include management plane processing circuitry 920 configured to perform management plane processing-related operations as discussed herein (for example, generating an M-plane message). The management plane processing circuitry 920 may further be configured to execute management plane processing software 922 included on the one or more memories 904 to implement one or more functions described herein.

In various aspects, the one or more processors 902 may include synchronization plane processing circuitry 924 configured to perform synchronization plane processing-related operations as discussed herein (for example, generating the synchronization data 314, transmitting the synchronization data 314, or the like). The synchronization plane processing circuitry 924 may further be configured to execute synchronization plane processing software 926 included on the one or more memories 904 to implement one or more functions described herein.

In some implementations, the O-RU 900 may be configured to operate as the O-RU 208, described herein. In some more implementations, the O-RU 208 described herein may correspond to (or may be included in) the O-RU 900. For example, the one or more processors 902 or any remaining components of the O-RU 900 may enable the O-RU 900 to perform the operations of one or more processes (for example, the processes 600 and 700) described herein.

Some implementation examples are described in the following numbered aspects:

Aspect 1: A method to enable Grand Master switching for fronthaul synchronization, comprising: in an Open-Radio Access Network (O-RAN) Distributed Unit (O-DU): transmitting an indication to an O-RAN Radio Unit (O-RU) to operate as a synchronization source for the O-DU, the indication being associated with a synchronization drift in the O-DU; receiving synchronization data from the O-RU; and restoring synchronization in the O-DU based on the synchronization data.

Aspect 2: The method of aspect 1, further comprising: receiving, from the O-RU, a capability message indicating a capability of the O-RU to operate as the synchronization source for the O-DU, wherein the transmission of the indication to the O-RU is based on the received capability message when the capability message indicates that the O-RU is capable of operating as the synchronization source for the O-DU.

Aspect 3: The method of aspect 2, wherein the capability message is further indicative of a switch time-period, and the switch time-period corresponds to a synchronization window usable for synchronization restoration.

Aspect 4: The method of any of aspects 2 through 3, further comprising: transmitting, to the O-RU, an acknowledgment indicator in response to the received capability message.

Aspect 5: The method of any of aspects 1 through 4, further comprising: detecting the synchronization drift in the O-DU.

Aspect 6: The method of any of aspects 1 through 5, further comprising: transmitting, to the O-RU, a holdover message indicating the synchronization drift in the O-DU.

Aspect 7: The method of aspect 6, wherein the transmission of the holdover message is prior to the transmission of the indication to operate as the synchronization source for the O-DU.

Aspect 8: The method of any of aspects 1 through 7, further comprising: transmitting, to the O-RU, a synchronization response based on the restoration of synchronization in the O-DU.

Aspect 9: The method of any of aspects 1 through 8, wherein the restoration of synchronization in the O-DU is with respect to at least one of time, phase, or frequency.

Aspect 10: A method to enable Grand Master switching for fronthaul synchronization, comprising: in an Open-Radio Access Network (O-RAN) Radio Unit (O-RU): receiving, from an O-RAN Distributed Unit (O-DU), an indication to operate as a synchronization source for the O-DU; and transmitting synchronization data to the O-DU in response to the indication.

Aspect 11: The method of aspect 10, further comprising: transmitting, to the O-DU, a capability message indicating a capability of the O-RU to operate as the synchronization source for the O-DU.

Aspect 12: The method of aspect 11, wherein the reception of the indication from the O-DU is based on the transmitted capability message.

Aspect 13: The method of aspect 11, wherein the capability message is further indicative of a switch time-period of the O-RU.

Aspect 14: The method of aspect 13, wherein the switch time-period is less than a holdover expiration time-period associated with the O-DU.

Aspect 15: The method of any of aspects 11 through 14, further comprising receiving, from the O-DU, an acknowledgment indicator in response to the transmitted capability message.

Aspect 16: The method of any of aspects 10 through 15, wherein the reception of the indication from the O-DU is in response to a synchronization drift in the O-DU.

Aspect 17: The method of any of aspects 10 through 16, further comprising: receiving, from the O-DU, prior to the reception of the indication, a holdover message indicating a synchronization drift in the O-DU.

Aspect 18: The method of any of aspects 10 through 17, further comprising: receiving, from the O-DU, a synchronization response based on a restoration of synchronization in the O-DU, wherein the restoration of synchronization in the O-DU is based on the synchronization data.

Aspect 19: The method of any of aspects 10 through 18, further comprising: transmitting the synchronization data to one or more additional O-RUs cascaded to the O-RU in response to the indication.

Aspect 20: An apparatus to enable Grand Master switching for fronthaul synchronization in an Open-Radio Access Network (O-RAN) Distributed Unit (O-DU), comprising: one or more processors; one or more memories coupled with the one or more processors; and instructions stored in the one or more memories and executable by the one or more processors to cause the apparatus to perform a method of any of aspects 1 through 9.

Aspect 21: A non-transitory computer-readable medium storing code to enable Grand Master switching for fronthaul synchronization, at an Open-Radio Access Network (O-RAN) Distributed Unit (O-DU), the code comprising instructions executable by one or more processors to perform a method of any of aspects 1 through 9.

Aspect 22: An apparatus to enable Grand Master switching for fronthaul synchronization in an Open-Radio Access Network (O-RAN) Radio Unit (O-RU), comprising: one or more processors; one or more memories coupled with the one or more processors; and instructions stored in the one or more memories and executable by the one or more processors to cause the apparatus to perform a method of any of aspects 10 through 19.

Aspect 23: An apparatus to enable Grand Master switching for fronthaul synchronization in an Open-Radio Access Network (O-RAN) Radio Unit (O-RU), comprising at least one means for performing a method of any of aspects 10 through 19.

Aspect 24: A non-transitory computer-readable medium storing code to enable Grand Master switching for fronthaul synchronization in an Open-Radio Access Network (O-RAN) Radio Unit (O-RU), the code comprising instructions executable by one or more processors to perform a method of any of aspects 10 through 19.

It should be noted that the methods described herein describe possible implementations, and that the operations and the steps may be rearranged or otherwise modified and that other implementations are possible. Further, aspects from two or more of the methods may be combined.

As used herein, the phrase 'one or more processors are configured to' may encompass various implementations, including but not limited to: (A) processors that are programmed and capable of performing the function, regardless of whether execution is caused at a given time; (B) processors actively executing instructions to perform the function; and (C) processors that, when triggered by an event or condition, initiate execution of the function. This interpretation is not intended to limit the scope of the claims to only an actively functioning device.

Unless explicitly stated otherwise, the recitation of "one or more processors configured to" is not intended to require that all operations be performed by the same individual processor. Rather, the described functionality may be distributed among multiple processors operating individually or collectively, including configurations in which different processors are configured to perform different subsets of the operations. Such distribution may be static or dynamic and concurrent or sequential.

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. An Open-Radio Access Network (O-RAN) Distributed Unit (O-DU), comprising:
one or more memories; and
one or more processors coupled to the one or more memories, wherein:
the one or more processors are configured to cause the O-DU to:
transmit an indication to an O-RAN Radio Unit (O-RU) to operate as a synchronization source for the O-DU, wherein:
the indication is associated with a synchronization drift in the O-DU;
receive synchronization data from the O-RU; and
restore synchronization in the O-DU based on the synchronization data.

2. The O-DU of claim 1, wherein:
the one or more processors are further configured to cause the O-DU to:
receive, from the O-RU, a capability message indicating a capability of the O-RU to operate as the synchronization source for the O-DU, wherein:
the transmission of the indication to the O-RU is based on the received capability message when the capability message indicates that the O-RU is capable of operating as the synchronization source for the O-DU.

3. The O-DU of claim 2, wherein:
the capability message is further indicative of a switch time-period, wherein:
the switch time-period corresponds to a synchronization window usable for synchronization restoration.

4. The O-DU of claim 2, wherein:
the one or more processors are further configured to cause the O-DU to:
transmit, to the O-RU, an acknowledgment indicator in response to the received capability message.

5. The O-DU of claim 1, wherein:
the one or more processors are further configured to cause the O-DU to:
detect the synchronization drift in the O-DU.

6. The O-DU of claim 1, wherein:
the one or more processors are further configured to cause the O-DU to:
transmit, to the O-RU, a holdover message indicating the synchronization drift in the O-DU.

7. The O-DU of claim 6, wherein:
the transmission of the holdover message is prior to the transmission of the indication to operate as the synchronization source for the O-DU.

8. The O-DU of claim 1, wherein:
the one or more processors are further configured to cause the O-DU to:
transmit, to the O-RU, a synchronization response based on the restoration of synchronization in the O-DU.

9. The O-DU of claim 1, wherein:
the restoration of synchronization in the O-DU is with respect to at least one of time, phase, or frequency.

10. An Open-Radio Access Network (O-RAN) Radio Unit (O-RU), comprising:
one or more memories; and
one or more processors coupled to the one or more memories, wherein:
the one or more processors are configured to cause the O-RU to:
receive, from an O-RAN Distributed Unit (O-DU), an indication to operate as a synchronization source for the O-DU; and
transmit synchronization data to the O-DU in response to the indication.

11. The O-RU of claim 10, wherein:
the one or more processors are further configured to cause the O-RU to:
transmit, to the O-DU, a capability message indicating a capability of the O-RU to operate as the synchronization source for the O-DU.

12. The O-RU of claim 11, wherein:
the reception of the indication from the O-DU is based on the transmitted capability message.

13. The O-RU of claim 11, wherein:
the capability message is further indicative of a switch time-period of the O-RU.

14. The O-RU of claim 13, wherein:
the switch time-period is less than a holdover expiration time-period associated with the O-DU.

15. The O-RU of claim 11, wherein:
the one or more processors are further configured to cause the O-RU to:
receive, from the O-DU, an acknowledgment indicator in response to the transmitted capability message.

16. The O-RU of claim 10, wherein:
the reception of the indication from the O-DU is in response to a synchronization drift in the O-DU.

17. The O-RU of claim 10, wherein:
prior to the reception of the indication, the one or more processors are further configured to cause the O-RU to:
receive, from the O-DU, a holdover message indicating a synchronization drift in the O-DU.

18. The O-RU of claim 10, wherein:
the one or more processors are further configured to cause the O-RU to:
receive, from the O-DU, a synchronization response based on a restoration of synchronization in the O-DU, wherein:
the restoration of synchronization in the O-DU is based on the synchronization data.

19. The O-RU of claim 10, wherein:
the one or more processors are further configured to cause the O-RU to:
transmit the synchronization data to one or more additional O-RUs cascaded to the O-RU in response to the indication.

20. A synchronization method in an Open-Radio Access Network (O-RAN) Distributed Unit (O-DU), comprising:
transmitting, an indication to an ORAN Radio Unit (O-RU) to operate as a synchronization source for the O-DU, wherein:
the indication is associated with a synchronization drift in the O-DU;
receiving, from the O-RU, synchronization data; and
restoring synchronization in the O-DU based on the synchronization data.
